(19) United States
(12) Patent Application Publication
(10) Pub. No.: US 2021/0404172 A1
(43) Pub. Date: Dec. 30, 2021

(54) CONCEALED STORAGE SYSTEM AND METHOD

(71) Applicant: Craig Wildvank, Long Beach, CA (US)

(72) Inventor: Craig Wildvank, Long Beach, CA (US)

(21) Appl. No.: 16/914,044

(22) Filed: Jun. 26, 2020

(51) Int. Cl. E04B 1/343; E05G 1/024; G08C 17/02

(52) U.S. Cl. CPC E04B 1/34363; G08C 17/02; E05G 1/024; E04B 1/34305

(57) ABSTRACT

A concealed storage system for storing objects is disclosed. The system has an outer casing having a top portion and an open bottom portion defining a hollow interior of the outer casing, an inner casing securely and movably positioned in the interior of the outer casing, wherein the inner casing comprises one or more compartments for securely storing objects, a top portion and a bottom portion, a pulley system securely and operatively positioned on a top portion of the inner casing, wherein the pulley system moves the inner casing in and out of the outer casing when actuated by a motor from a recessed state and non-recessed state; and a normalized conductive object attached to the bottom portion of the inner casing such that when the inner casing is in its recessed state, the normalized conductive object is flush to a ceiling.

### FIELD OF THE INVENTION

The present invention relates generally to a concealed storage system and method for concealing items or objects of value. More specifically, the present invention relates to a concealed storage system to enable a user to securely store valuable objects in a concealed manner, and also conveniently and quickly access the concealed storage system which is securely placed in a subsurface or overhead surface location within a structure.

### BACKGROUND

A safe, vault or coffer is a secure lockable box used for securing valuable objects against theft and/or damage from fire. The safe is usually a hollow cuboid or cylinder, with one face being removable or hinged to form a door that is lockable or closable. The body and door may be cast from metal (such as steel). Safes generally include one or more specifications such as burglar-resistance, fire resistance, and/or water and dust resistance in order to protect the stored valuable objects and other equipment from burglars, fire, water, and other impacts.

Currently, there are different hidden safes available in the market which are used for safely storing and protecting the valuable objects such as jewelry, documents, and other valuables. However, burglars or thieves easily find the existing hidden in-home or in business safes using metal detectors against the walls, ceilings, and other surfaces. This is because the existing hidden safes are made of metals and other conductive materials and are hidden in walls behind paintings or bookcases as is known.

As an example, U.S. Pat. No. 6,292,960 to Larry D. Bowling discloses a hidden safe for concealment of firearms and other valuables therein, the safe being sized and shaped to replace bed box-springs. The safe includes a top surface to support a mattress of a bed, a bottom surface to engage a supporting floor, a plurality of exterior side walls and corners being sized and shaped to support a mattress bed. The safe includes an internal storage cavity bounded by interior walls a lower floor. The safe includes side wall openings through at least one of the exterior side walls and through respective interior walls, into which one or more drawers can be inserted into the storage cavity. Each drawer is lockable and concealed from view when inserted into the safe in a concealed position, and each drawer is extendable outwards from the storage cavity into an exposed position. A rolling means supports each drawer and allows each drawer to be moved along at least one pair of roller tracks positioned on an interior wall within the storage cavity, providing a user ease of opening and loading each drawer in the exposed position, and allowing closing each drawer to the concealed position into the concealed safe that is hidden under a mattress and appears as a bed box-springs.

Another exemplary device is disclosed in U.S. Pat. No. 8,833,876 to Earl Lee, which discloses a wall depository having storage receptacle assembly adapted for secure, concealed placement in an opening formed within a building wall, generally between a pair of wall studs, the receptacle defined by a rear wall, a left side wall, a right side wall, a top wall, and a bottom wall; and a frame assembly hingedly coupled to the storage receptacle assembly and adapted to pivot outwardly to expose a storage receptacle and to close inwardly to secure and conceal the storage receptacle.

However, the existing hidden safes are made of ferrous and/or conductive materials so burglars could easily find it using the metal detectors. Further, the user cannot conveniently and simply access the hidden safes, which are placed in locations that are difficult to access, and if they are not difficult to access, they are too accessible to burglars and thieves.

In light of the above-mentioned drawbacks, there is a need for a concealed storage system to enable a user to securely store valuable objects and other equipment so that burglars cannot find them, and also, conveniently and quickly access the hidden safe.

### SUMMARY OF THE INVENTION

The present invention discloses an actuated concealed storage system that is hidden by a normalized metal object in a ceiling, for example a fire alarm, speaker, can lights or vents. Further, the present invention discloses a system to enable a user to securely store valuable objects and other equipment and also conveniently and quickly access the hidden safe which is movably placed in a ceiling or a subsurface location beneath the floor of a structure. As used herein, the term normalized metal object refers to objects and fixtures that are regularity or ordinary be hanging or installed in a home or office such as but not limited to light fixtures (can lights), smoke alarms, vents, and speakers.

In one embodiment, the concealed storage system enables the user to securely store the valuable objects such as, but not limited to, jewelry, firearms, and documents and allows for convenient and quick access the concealed system that which is securely placed in a celling or a subsurface location. In one embodiment, the concealed storage system comprises a concealed storage system for storing objects, the system comprising an outer casing having a top portion and an open bottom portion defining a hollow interior of the outer casing an inner casing securely and movably positioned in the interior of the outer casing, wherein the inner casing comprises one or more compartments for securely storing objects, a top portion and a bottom portion; a pulley system securely and operatively positioned on a top portion of the inner casing, wherein the pulley system moves the inner casing in and out of the outer casing when actuated by a motor from a recessed state and non-recessed state; and a normalized conductive object attached to the bottom portion of the inner casing such that when the inner casing is in its recessed state, the normalized conductive object is flush to a ceiling.

In another embodiment, a method for storing objects is provided. The method comprises providing an outer casing having a top portion and an open bottom portion defining a hollow interior of the outer casing, an inner casing securely and movably positioned in the interior of the outer casing, wherein the inner casing comprises one or more compartments for securely storing objects, a top portion and a bottom portion, actuating a motor attached to a pulley system that is securely and operatively positioned on a top portion of the inner casing, lowering the inner casing in and out of the outer casing via the pulley system when actuated by a motor from a recessed state to non-recessed state; and positioning a normalized conductive object attached to the bottom portion of the inner casing flush to a ceiling.

The pulley system is operatively connected to the motor for moving the inner casing up and down, and in some cases, rotationally, each occurring via the user's smart device (e.g., smartphone). In one embodiment, the user device is wirelessly connected to the motor via a wireless communication network using a software mobile application for controlling the pulley system or actuating system, thereby enabling the user to simply control the movement of the inner casing using the user device with the software application for accessing the stored valuable objects and equipment. In some embodiments, the pulley system is a winch system and is also further configured to rotate the inner casing to ensure the user can access the compartments.

In one embodiment, the concealed storage system is made of non-conductive metals, thereby protecting it from burglars to find using metal detectors against the walls, ceilings, and other surfaces. In other embodiments, it is made of a metal or conductive housing but is disguised by a normalized conductive item such as a heating or cooling grate or vent, speaker, can light, or a fire or carbon monoxide detector. In this way, a burglar with a metal detector would likely be deceived by the normalized metal object because the burglar would believe that the metal detector is detecting the normalized metal object and will likely look no further into the ceiling where the storage system is actually located. As such, it is highly unlikely that the burglar would tear out the ceiling searching for the safe the same way they would a wall safe that is not covered by a normalized metal object.

In one embodiment, the motor is in communication with the mobile application via wireless communication network is at least any one-off, but not limited to, Bluetooth®, Wi-Fi, wireless local area network (WLAN), and radio communication. In one embodiment, the user device is at least any one-off, but not limited to, a smartphone, a tablet, a computer, a laptop, and a personal digital assistant (PAD). In one embodiment, the concealed storage system further comprises a normalized object, for example, a smoke detector, can light, speaker or vent. The normalized object is conductive or a metal or have metal parts and at least a conductive material so that it would set off a metal detector.

In one embodiment, the inner casing comprises one or more compartments: an upper compartment for storing jewelry and ornaments, a middle compartment, and a lower compartment. In one embodiment, the upper compartment includes one or more hangers for hanging the jewelry and ornaments. In one embodiment, the pulley system includes a casing, pulley attachments, a pair of wheels or sheaves, a bearing, and a release pin. In one embodiment, the pair of wheels is a lower pulley wheel and an upper pulley wheel. The lower pulley wheel is rotatably positioned and supported on the bearing and is secured using the release pin. The pulley system may be changed by releasing the release pin from the bearing. The lower pully wheel freely rotates or spins on an axle or the bearing inside the casing pully attachments.

In one embodiment, the inner casing comprises an adjustable head, which is securely affixed to the top portion of the inner casing using fasteners, for example, screws. In one embodiment, the adjustable head enables the user to rotate the inner casing. The adjustable head comprises at least four fins i.e., a first fin, a second fin, a third fin, and a fourth fin. The four fins are used to support and keep the inner casing at a predefined rotational angle, (plus or minus 10⁰). In one embodiment, the adjustable head is provided with at least two slot sliders: a first slot slider and a second slot slider. Each slot further comprises latches and locking mechanisms, respectively. In some embodiments, the adjustable head is electronically operated for rotating the inner casing. As such, the sliders and the locking mechanisms may be electrically and operatively connected to the motor as well, respectively, or may be rotated manually.

In one embodiment, the outer housing further comprises a connector with a spring load. The spring load and a sensor is securely connected to the pully system in case the inner housing is overloaded with weight and it will provide a signal for shutting off in order to avoid breaking the pulley line. The sensor is positioned for measuring the pressure or weight of the load. The outer housing further comprises a release mechanism with a clip. The release mechanism enables the user to easily release the inner casing from the outer housing through the aperture in case of power down by releasing the clip.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of a concealed system used by a user for safely storing valuable objects and other equipment in an embodiment of the present invention.

FIG. 2 shows a perspective view of an inner casing of the concealed storage system in one embodiment of the present invention.

FIG. 3 shows a bottom perspective view of the inner casing of the concealed storage system in one embodiment of the present invention.

FIG. 4 shows a top perspective view of the inner casing of the concealed storage system in one embodiment of the present invention.

FIG. 5 shows a side perspective view of an outer housing of the concealed storage system with a motor in one embodiment of the present invention.

FIG. 6 shows a top perspective view of the outer housing of the concealed storage system in one embodiment of the present invention.

FIG. 7 shows a bottom perspective view of the outer housing of the concealed storage system in one embodiment of the present invention.

FIG. 8 shows a perspective view of an inner portion of the concealed storage system in one embodiment of the present invention.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Embodiments of the system are discussed below with reference to the examples. However, those skilled in the art will readily appreciate that the detailed description given herein with respect to these examples is for explanatory purposes as the system extends beyond these limited embodiments. For example, it should be appreciated that those skilled in the art will, in light of the teachings of the present system, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the system that are too numerous to be listed but that all fit within the scope of the system. Also, singular words should be read as plural and vice versa and masculine as feminine and vice versa, where appropriate, and alternative embodiments do not necessarily imply that the two are mutually exclusive.

It is to be further understood that the present system is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present system. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this system belongs. Preferred methods, techniques, devices, and materials are described, although any methods, techniques, devices, or materials similar or equivalent to those described herein may be used in the practice or testing of the present system.

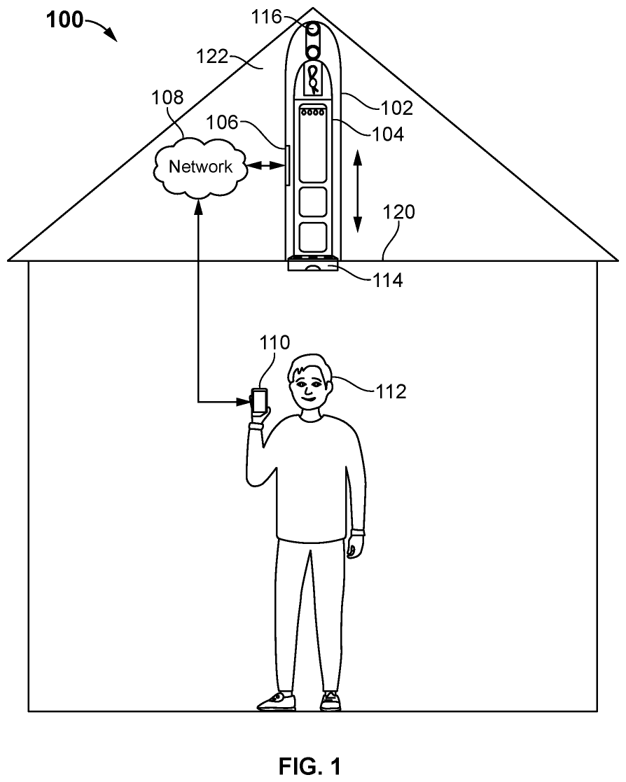

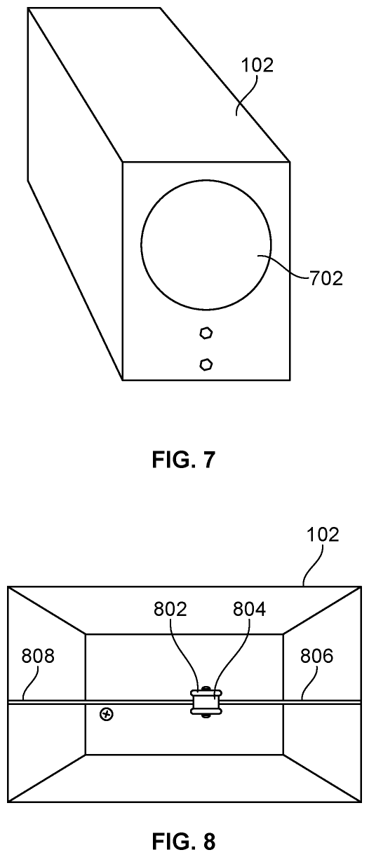

Referring to FIG. 1, a concealed storage system and system 100 used by a user 112 for safely storing valuable objects and other equipment in one embodiment is disclosed. In one embodiment, the concealed storage system 100 enables the user 112 to securely store the valuable objects such as, but not limited to, jewelry, firearms and documents and also conveniently and quickly access the hidden system 100, which is securely placed overhead in a ceiling 120 compartment or attic 122, or in a subsurface location beneath the floor of a structure. In one embodiment, the concealed storage system 100 comprises an outer casing or outer housing 102 having a cavity or an aperture 702 (shown in FIG. 7), an inner casing 104, a motor 106, a user device 110, and a pully system 116.

In one embodiment, the outer housing 102 is statically of fixedly disposed or positioned above the ceiling in a cavity between the ceiling and roof and is accessible via attic or crawl space between the ceiling and roof. Is static and acts as a buttress. In one embodiment, the inner casing 104 is securely and movably positioned in the aperture 702 of the outer casing 102. In one embodiment, the pulley system 116 is securely and operatively positioned on a top portion of the inner casing 104 and is configured to move the inner casing 104 up and down, and in some cases rotationally, using the motor 106. The pulley system 116 is operatively connected to the motor 106 for moving the inner casing 104. In one embodiment, the user device 110 wirelessly connects to the motor 106 via a wireless communication network 108 using a software mobile application for controlling the pulley system 116, thereby enabling the user 112 to control the movement of the inner casing 104 using the user device 110 with the software application for accessing the stored valuable objects and equipment. In some embodiments, the pulley system 116 may be a winch system and is further configured to rotate the inner casing 104. In other embodiments, any pneumatic lifting system may be used.

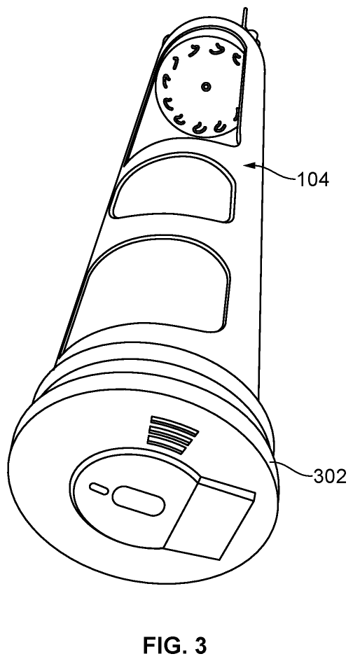

In one embodiment, the concealed storage system 100 is made of non-conductive metals, thereby protecting it from burglars to find using metal detectors against the walls, ceilings, and other surfaces. However, in other embodiments, to ensure strength and fireproof aspects of the device, it is made of a conductive metal that is concealed by a normalized object that is also metal or conductive as further described herein. In one embodiment, the wireless communication network 108 may be Bluetooth®, Wi-Fi, wireless local area network (WLAN), and/or radio communication. In one embodiment, the user device 110 is at least any one of a smartphones, a tablet, a computer, a laptop, and a personal digital assistant (PAD). In one embodiment, the concealed storage system 100 further comprises a normalized object 114 attached at an end of the inner casing 102, for example, a smoke detector 302 (shown in FIG. 3). However, the normalized object may be also be a speaker, can light, or vent. The normalized object 114 is constructed of metal or have metal parts or at least a conductive material located therein.

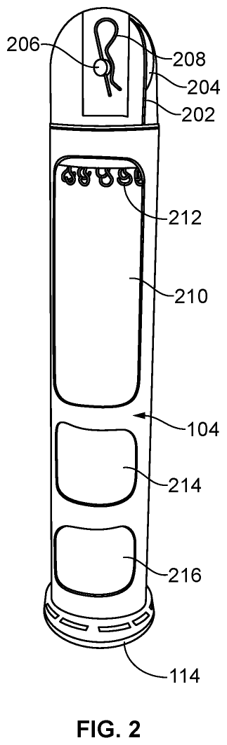

Referring now to FIG. 2, the inner casing 104 of the concealed storage system 100 is disclosed. In one embodiment, the inner casing 104 comprises one or more compartments include an upper compartment 210 for storing jewelry and ornamental goods for example, a middle compartment 214, and a lower compartment 216. In one embodiment, the upper compartment 210 may comprise one or more hangers 212 for hanging the jewelry and ornamental goods. In one embodiment, the middle compartment 214 may be an enclosed safe with a lock combating or fingerprint or face recognition combination. The pulley system 116 comprises casing pulley attachments 202, a pair of wheels or sheaves (lower pully wheel 204 shown), a bearing 206, and a release pin 208. In one embodiment, the pair of wheels may comprise a lower pulley wheel 204 and an upper pulley wheel 804 (shown in FIG. 8). The lower pulley wheel 204 is rotatably positioned and supported on the bearing 206 and is secured using the release pin 208. The lower pulley wheel 204 may be changed by releasing the release pin 208 from the bearing 206. The lower pully wheel 204 freely rotates or spins on an axle or the bearing 206 inside the casing pully attachments 202. In one embodiment, the normalized object 114, for example, a smoke detector or smoke alarm 302 (shown in FIG. 3) is secured to one end of the inner casing 104.

Referring to FIG. 3, the normalized object having metal therein is a smoke detector 302 secured to the inner casing 104. In an exemplary embodiment, the smoke detector 302 is securely affixed to a bottom of the inner casing 104. The smoke detector 302 conceals the concealed storage system 100 and protect it from burglars to find using metal detectors against the walls, ceilings, and other surfaces. In this way, a burglar with a metal detector would be deceived by the normalized metal object—in this case the smoke detector 302—because the burglar would believe that the metal detector is detecting the normalized metal object, and will likely look no further into the ceiling where the storage system actually located. As such, it is highly unlikely that the burglar would tear out the ceiling searching for the storage the same way they would a wall safe that is not covered by a normalized metal object. A metal heating or cooling grate or surround sound type speaker may be employed as well. As discussed, a speaker, vent, or a lighting fixture may also be employed and attached to the bottom of the inner housing 102 amongst a variety of normalized metal object.

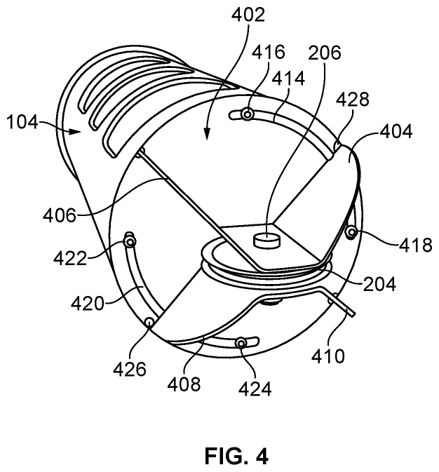

Referring to FIG. 4, the top portion of the inner casing 104 is disclosed. In one embodiment, the inner casing 104 comprises an adjustable head 402, which is securely but rotationally affixed to the top portion of the inner casing 104 using fasteners (426 and 428), for example, screws. In one embodiment, the adjustable head 402 is configured to enable the user 112 to rotate the inner casing 104. In one embodiment, the adjustable head 402 comprises at least four fins i.e., a first fin 404, a second fin 406, a third fin 408, and a fourth fin 410. The four fins are used to support and keep the inner casing 104 at a rotational angle, but not limited to, + or −10⁰. In one embodiment, the adjustable head 402 is provided with at least two slot sliders i.e., a first slot slider 414 and a second slot slider 420. Each slot further comprises fasteners (418 and 424) and locking mechanisms (416 and 422), respectively. It should be noticed that they are interchangeable and may comprise another type of latches and fasteners. In some embodiments, the adjustable head 402 could be electronically operated for rotating the inner casing 104. As such, the sliders (414 and 420) and the locking mechanisms (416 and 422), would be electrically and operatively connected to the motor 106 as well, respectively. The user 112 could turn the adjustable head 402 and also screws could lock it in depending upon the requirement of the user 112. Other locking mechanisms may be employed as well. In operator, the fasteners are loosened to so that the inner hosing 104 can be twisted to a desired rotational angle. Then, the user may tighten the latches to lock the inner housing into place. The fasteners and/or locks engage with the top of inner housing which may have corresponding sliders to rotate the inter housing then lock it into place using locks. In optional embodiments, the latches may mate to the body of the housing.

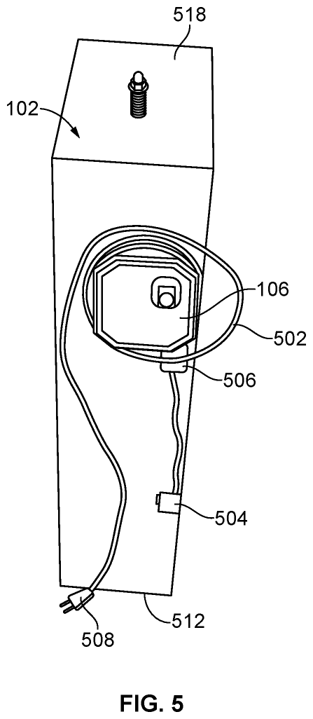

Referring now to FIG. 5, the outer housing 102 of the concealed storage system 100 with the motor 106 is disclosed. In one embodiment, the motor 106 is securely connected to the outer housing 102. In one embodiment, the motor 106 is any type actuator. In one embodiment, the motor 106 is electrically connected to a power supply using an electrical cable or conduit 502 having a male portion of plug 508. The outer housing 102 further comprises one or more cable clips (504 and 506) and also a top portion 518 and a bottom portion 512. In some embodiments, the motor 106 may be powered by using a battery that is connected to a solar power system or other green energy systems.

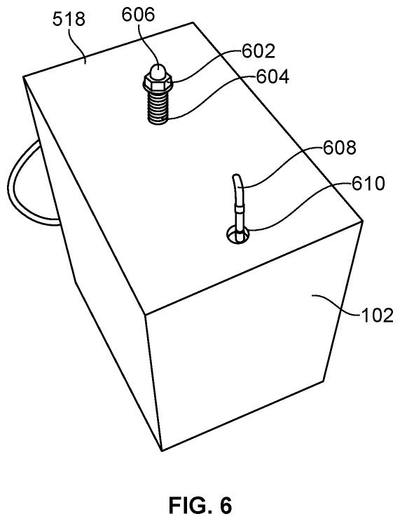

Referring now to FIG. 6, the top portion 518 of the outer housing 102 is shown. In one embodiment, the outer housing 102 further comprises a connector 602 with a spring load 604. In one embodiment, the spring load 604 is securely connected to the pully system 116 in case of overload weight and it will provide a signal for shutting off in order to avoid breaking of the pulley line. In one embodiment, a sensor 606 is placed for measuring the pressure or weight of the load. In one embodiment, the outer housing 102 further comprises a release mechanism 608 with a clip 610. The release mechanism 608 enables the user 112 to easily release the inner casing 104 from the outer housing 102 through the aperture in case of power down by releasing the clip 610. The sensor 606 is communicatively coupled to the mobile application to alert the user of an overload condition via alarm or notification.

Referring now to FIGS. 7 and 8, the inside of the outer housing 102 is shown. In one embodiment, the outer housing 102 has an aperture 702 for receiving the inner casing 104. In one embodiment, the pulley system 116 comprises a sheave 802 and an upper pulley wheel 804. The sheave 802 rotatably supports the upper pulley wheel 804 with pulley lines (806 and 808). The pulley lines 806 and 808 are coupled to the lower pulley wheels as well and operate to lift the inner casing up into the outer casing and lower the inner casing down from the outer casing as shown by the arrow in FIG. 1.

Advantageously, the concealed system 100 enables the user 112 to securely store the valuable objects such as, but not limited to, ornaments and documents and also conveniently and quickly access the hidden system 100, which is securely placed in a subsurface location beneath the floor of a structure. The concealed storage system 100 is made of, but not limited to, non-conductive metals, thereby protecting it from burglars to find using metal detectors against the walls, ceilings, and other surfaces.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A concealed storage system for storing objects, the system comprising:
an outer casing having a top portion and an open bottom portion defining a hollow interior of the outer casing;
an inner casing securely and movably positioned in the interior of the outer casing, wherein the inner casing comprises one or more compartments for securely storing objects, a top portion and a bottom portion;
a pulley system securely and operatively positioned on a top portion of the inner casing, wherein the pulley system moves the inner casing in and out of the outer casing when actuated by a motor from a recessed state and non-recessed state; and
a normalized conductive object attached to the bottom portion of the inner casing such that when the inner casing is in its recessed state, the normalized conductive object is flush to a ceiling.

2. The concealed storage system of claim 1, wherein the outer casing is securely affixed in a compartment between the ceiling and a roof, and wherein the inner casing, when actuated by the motor, lowers into its non-recessed state to reveal itself to a user from the ceiling.

3. The system of claim 1, further comprising a user device for wirelessly connecting to the motor via a wireless communication network using a software application for controlling the pulley system, thereby enabling a user to control the movement of the inner casing using the user device with the software application for accessing the compartments;

4. The concealed storage system of claim 1, wherein the normalized object in the ceiling is a smoke detector, vent, speaker, light fixture, or any combination thereof.

5. The concealed storage system of claim 2, wherein the pulley system is operatively connected to the motor for moving the inner housing down to the non-recessed position so a user can access the objects stored in the one or more compartments of the inner casing.

6. The concealed storage system of claim 3, wherein the mobile application is in wireless communication with the motor via a network.

7. The concealed storage system of claim 6, wherein the mobile application is downloadable on the user device, wherein the user device is a smart device.

8. The concealed storage system of claim 1, further comprising an adjustable head attached to the top portion of the inner casing, wherein the adjustable head allows the user to rotate the inner casing to a desired rotational position.

9. The concealed storage system of claim 8, wherein the adjustable head comprises at least a fin on top of the head for connection to the pulley system, and further, to keep the inner casing at the desired rotational angle.

10. The concealed storage system of claim 7, wherein the adjustable head comprises at least one slot slider and a corresponding fastening and locking mechanisms to rotate the head to the desired angle and lock it in place.

11. The concealed storage system of claim 7, wherein the motor is in communication with the adjustable head to provide rotating force when unstructured from the mobile application.

12. The concealed storage system of claim 1, further comprising a spring and sensor connected to the pulley system through the top portion of the outer housing to signal defined in the top portion of the outer housing, wherein the spring and sensor define an overload and signal the motor to shut off.

13. The concealed storage system of claim 1, further comprising a release mechanism having a clip therethrough to release inner housing in case of a power down event.

14. A method for storing objects, the method comprising:
providing an outer casing having a top portion and an open bottom portion defining a hollow interior of the outer casing, an inner casing securely and movably positioned in the interior of the outer casing, wherein the inner casing comprises one or more compartments for securely storing objects, a top portion and a bottom portion;
actuating a motor attached to a pulley system that is securely and operatively positioned on a top portion of the inner casing;
lowering the inner casing in and out of the outer casing via the pulley system when actuated by a motor from a recessed state to non-recessed state; and
positioning a normalized conductive object attached to the bottom portion of the inner casing flush to a ceiling.

15. The method of claim 14, wherein the outer casing is securely affixed in a compartment between the ceiling and a roof, and wherein the inner casing, when actuated by the motor, raising the inner casing from recessed to a non-recessed state.

16. The method of claim 14, wherein actuating the motor comprises using a user device for wirelessly connecting the motor via a wireless communication network using a software application for controlling the pulley system, thereby enabling a user to control the movement of the inner casing using the user device with the software application for accessing the compartments.

17. The method of claim 14, wherein the normalized object in the ceiling is a smoke detector, vent, speaker, light fixture, or any combination thereof.

18. The method of claim 17, wherein the mobile application is downloadable on the user device, wherein the user device is a smart device.

19. The method of claim 14, further adjusting an adjustable head attached to the top portion of the inner casing, wherein the adjustable head allows the user to rotate the inner casing to a desired rotational position.

20. The method of claim 14, wherein the adjustable head comprises at least a fin on top of the head for connection to the pulley system, and further, to keep the inner casing at a desired rotational angle.
